(19) United States
(12) Patent Application Publication
(10) Pub. No.: US 2019/0368416 A1
(43) Pub. Date: Dec. 5, 2019

(54) Exhaust Gas Turbocharger

(71) Applicant: IHI Charging Systems International GmbH, Heidelberg (DE)

(72) Inventors: Oliver BAUMANN, Wiesloch (DE); Epameinondas CHRISTODOULOPOULOS, Heidelberg (DE); Joachim DELITZ, Heddesbach (DE); Matthias DEUTSCHER, Haßloch (DE); Marek KWASNITZA, Wiesloch (DE)

(73) Assignee: IHI Charging Systems International GmbH, Heidelberg (DE)

(21) Appl. No.: 16/475,724

(22) PCT Filed: Apr. 13, 2018
(86) PCT No.: PCT/EP2018/000203

§ 371 Date: Jul. 3, 2019

(30) Foreign Application Priority Data
May 2, 2017 (DE) 10 2017 109 351.6

(51) Int. Cl. F02C 6/06; F01M 11/02

(52) U.S. Cl. CPC F02C 6/06; F01M 2011/021; F05D 2220/40; F01M 11/02

(57) ABSTRACT

An exhaust gas turbocharger has a flow-through exhaust gas guide section, a flow-through fresh air guide section and a bearing section arranged between the exhaust gas guide section and the fresh air guide section. It has a rotor assembly, comprising a turbine wheel which is rotatably accommodated in the exhaust gas guide section, a compressor wheel which is rotatably accommodated in the fresh air guide section, and a shaft which non-rotatably connects the compressor wheel with the turbine wheel, wherein the shaft is rotatably supported in the bearing section, and wherein a lubricant supply system with an inlet channel and an outlet channel is formed in the bearing section, via which lubricant may be supplied to the bearing elements of the bearing of the shaft, and wherein a lubricant-rejecting element is implemented. The lubricant-rejecting element comprises baffle elements for diverting a rotating proportion of the lubricant flow.

### TECHNICAL FIELD

The disclosure relates to an exhaust gas turbocharger.

### BACKGROUND

Exhaust gas turbochargers, in particular for motor vehicles, are known. The exhaust gas turbocharger serves to compress fresh air to be supplied to a combustion engine in order to supply the combustion engine with more combustion air than can be taken in by its stroke. Thereby, an inherent energy of the combustion engine's exhaust gas is utilized for operating a rotor assembly of the exhaust gas turbocharger. The rotor assembly comprises a turbine wheel which is rotatably accommodated in a flow-through exhaust gas guide section which is non-rotatably connected with a compressor wheel via a shaft, which is rotatably accommodated in a flow-through fresh air guide section. The exhaust gas flowing through the exhaust gas guide section is applied to the turbine wheel which drives the compressor wheel which is non-rotatably connected to the shaft, so that it may take in fresh air which after having been compressed may flow into the combustion engine.

The rotor assembly is supported rotable or rotatable, respectively, in the bearing section and comprises bearing elements for a low friction movement which are disposed in the bearing section where they may be provided with lubricant. Due to the arrangement of the bearing section between the exhaust gas guide section and the fresh air guide section as well as of the rotor assembly which at least partially penetrates each of the sections, the sections are thus connected in a flow-through manner. By means of a heat shield, for example, the bearing section is protected as far as possible against an excessive heat input from the exhaust gas flowing through the exhaust gas guide section.

However, it is likewise important that lubricant flowing through the bearing section cannot enter the fresh air guide section, in particular, and the exhaust gas guide section. Normally, the shaft comprises a so-called oil slinger ring near the fresh air guide section, and in an area near the exhaust gas guide section correspondingly formed sealing rings serve to prevent the transfer of lubricant into the exhaust gas guide section.

It was found that a certain proportion of lubricant can still enter the fresh air guide section via the oil slinger ring which is non-rotatably connected with the shaft. In order to achieve an improved sealing of the fresh air guide section, a lubricant-rejecting element is formed in the area of the fresh air guide section.

The lubricant has a gravity-induced proportion of the lubricant flow which, due to gravity, flows towards the earth's surface. Normally, this direction corresponds to the arrangement of a lubricant outlet channel of the bearing section. Furthermore, during operation of the exhaust gas turbocharger, the lubricant includes a proportion of the lubricant flow which is slung off the shaft due to the centrifugal force of the shaft caused by the rotation of the shaft during operation of the exhaust gas turbocharger and has a certain trajectory. In the following, this proportion of the lubricant flow will be referred to as rotating proportion of the lubricant flow.

Laid open patent application WO 2016/153963 A1 shows an exhaust gas turbocharger with a lubricant-rejecting element which comprises a ramp which points towards a lubricant sump in the area of a fresh air guide section of the exhaust gas turbocharger for the diversion of a gravity-induced proportion of the lubricant flow, so that the lubricant flowing onto the ramp is conveyed into the lubricant sump. In order to improve this diversion, the ramp comprises a guide element which is formed in a middle area of the ramp.

However, the diversion of the gravity-induced proportion of the lubricant flow alone is not sufficient to prevent a transfer of lubricant ingression into the fresh air guide section.

### SUMMARY

The invention is based on the object to indicate an exhaust gas turbocharger which comprises a further reduced transfer of lubricant into the fresh air guide section and/or the exhaust gas guide section.

This object is solved by an exhaust gas guide section for an exhaust gas turbocharger as claimed. Advantageous embodiments with suitable and non-trivial developments of the invention are indicated in the dependent claims.

The disclosed exhaust gas turbocharger comprises a flow-through exhaust gas guide section, a flow-through fresh air guide section and a bearing section which is arranged between the exhaust gas guide section and the fresh air guide section. In addition, it comprises a rotor assembly with a turbine wheel which is rotatably accommodated in the exhaust gas guide section, a compressor wheel which is rotatably accommodated in the fresh air guide section, and a shaft which non-rotatably connects the compressor wheel with the turbine wheel. The shaft is rotatably supported in the bearing section. In addition, a lubricant supply system with an inlet channel and an outlet channel is formed in the bearing section, via which lubricant may be supplied to the bearing elements of the shaft bearing. Furthermore, the exhaust gas turbocharger comprises a lubricant-rejecting element. The lubricant-rejecting element comprises a baffle element for the diversion of a rotating proportion of the lubricant flow.

During operation of the exhaust gas turbocharger, the lubricant flowing from the inlet channel into the outlet channel via the lubricant supply system impinges least partially on the rotating shaft, from which it is slung off due to the centrifugal force and undirectly hits an inner wall of the bearing section. This proportion of the lubricant flow, in the following referred to as rotating proportion of the lubricant flow, is captured by means of the baffle element formed at the lubricant-rejecting element on its way to the inner wall of the bearing section and may subsequently be supplied to the outlet channel. This prevents the rotating proportion of the lubricant flow from passing into the fresh air guide section. The baffle element is formed extending in the direction of a longitudinal axis of the exhaust gas turbocharger and in the circumferential direction of the shaft so that the rotating proportion of the lubricant flow may be aligned in the direction after having impinged on the baffle element.

In addition to the rotating proportion of the lubricant flow, the lubricant flow from the inlet channel into the outlet channel comprises a gravity-oriented proportion of the lubricant flow which flows towards the earth's surface because of the gravitational force. For aligning or diverting, respectively, this proportion of the lubricant flow, the lubricant-rejecting element comprises a guide element, wherein the guide element extends in the direction of a longitudinal axis of the exhaust gas turbocharger and in the direction of a longitudinal axis of the outlet channel. This is advantageous in that in addition to the rotating proportion of the lubricant flow, the gravity-oriented proportion of the lubricant flow may be conveyed into the outlet channel. Thereby, the transfer of lubricant into the fresh air guide section is almost completely prevented.

The lubricant-rejecting element is non-rotatably fixed in the bearing section. The advantage of the fixed and thus non-rotatable lubricant-rejecting element is a permanently invariable position relative to the outlet channel. This means that the lubricant may be supplied into the outlet channel via the lubricant-rejecting element as intended. If the lubricant-rejecting element could rotate with the shaft, capturing of lubricant might be possible, however, conveying it into the outlet channel cannot be ensured.

In another embodiment, the lubricant-rejecting element exhibits a U-shaped cross-section, wherein side walls for diverting the rotating proportion of the lubricant flow are formed and, in particular, a central portion is formed which connects the first side wall with the second side wall for diverting the gravity-oriented proportion of the lubricant flow. This results in a trough-type design of the lubricant-rejecting element for the collection of the lubricant, thereby achieving an effective capturing and transfer of the entire lubricant flow.

For specific diversion or passing, respectively, of the entire lubricant flow, the central portion is formed to protrude into the outlet channel as a virtual extension.

In another embodiment, the lubricant-rejecting element comprises a fastening component by means of which it may preferably be fixed in the bearing section.

In a cost-effective embodiment of the exhaust gas turbocharger, the fastening component is attached by material-bonding at the bearing section. Depending on the material of the fastening component, it is adhesive-bonded or welded. To provide a detachable connection, the fastening component is positively connected with the bearing section, wherein it comprises a clamping element, in particular a clamping lug, for a positive connection, by means of which it is secured at the bearing section. In a preferred embodiment, the clamping element is formed as an undercut fastening element.

It was found that an efficient reduction of the transfer of lubricant into the fresh air guide section may be achieved by positioning the lubricant-rejecting element in the area of a lubricant slinger ring which is non-rotatably connected with the shaft and encompassing it. The lubricant slinger ring serves to sling off lubricant impinging on the shaft, and is adapted to align the lubricant being slung off.

In another embodiment, the lubricant-rejecting element comprises a mounting diameter whose value is at least equal to the largest outer diameter of the lubricant slinger ring. This results in a significantly improved centering of the lubricant-rejecting element in the bearing section.

Further advantages, features and details are disclosed in the following description of a preferred exemplary embodiment as well as the drawing. The above-mentioned features and feature combinations as well as the features and feature combinations in the following description of the figures and/or shown in the figures alone are not only applicable in the indicated combination but also in other combinations or alone.

### BRIEF DESCRIPTION OF THE DRAWINGS

FIG. 1 is a perspective longitudinal section of a cut-out of a bearing section with a rotor assembly of an exhaust gas turbocharger according to the state of the art.

FIG. 2 is a longitudinal section of an exhaust gas turbocharger with a lubricant-rejecting element.

FIG. 3 is a perspective view of a lubricant-rejecting element in a first exemplary embodiment.

FIG. 4 is a perspective of the lubricant-rejecting element in a second exemplary embodiment.

FIG. 5 is a perspective longitudinal section of a bearing section of the exhaust gas turbocharger according to FIG. 2.

FIG. 6 is a perspective longitudinal section of a bearing section of the exhaust gas turbocharger with the lubricant-rejecting element according to FIG. 4.

FIG. 7 is a perspective sub-view of a cut-out of the bearing section according to FIG. 5.

FIG. 8 is a perspective view of the lubricant-rejecting element according to FIG. 3 in the installed condition.

FIG. 9 is a perspective view of the lubricant-rejecting element in in a third exemplary embodiment in the installed condition.

FIG. 10 is a perspective view of the lubricant-rejecting element according to FIG. 4 in the installed condition.

FIG. 11 is a detail view XI of the lubricant-rejecting element according to FIG. 10.

FIG. 12 is a perspective longitudinal section of the bearing section with the lubricant-rejecting element according to FIG. 4.

FIG. 13 is a longitudinal section of a bearing section with the lubricant-rejecting element according to FIG. 4.

### DETAILED DESCRIPTION

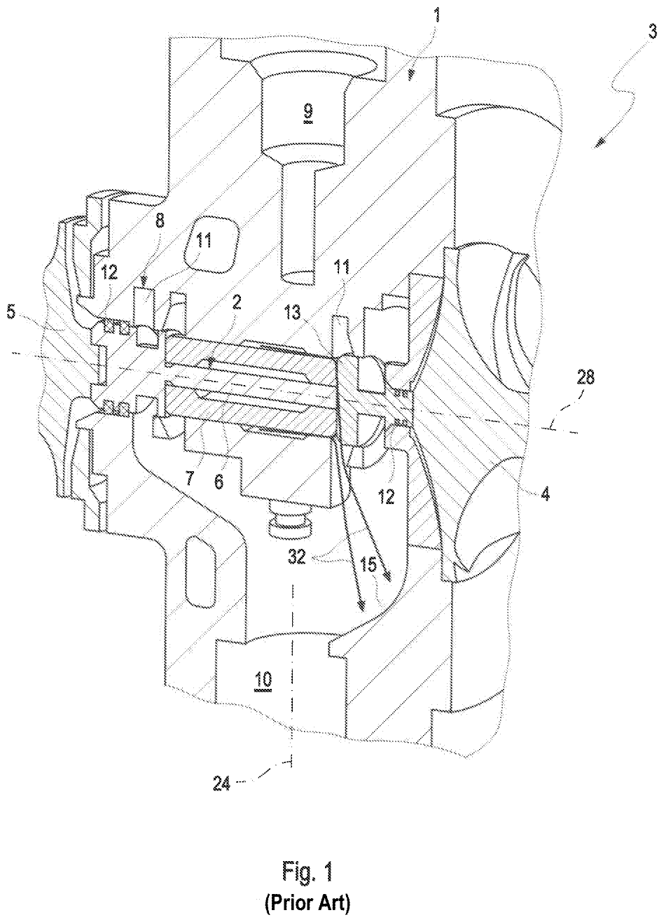

A bearing section 1 with a rotor assembly 2 according to the state of the art shown in FIG. 1 is provided for an exhaust gas turbocharger 3 which is arranged in an intake system (not shown in detail) or an exhaust system (not shown in detail), respectively, of a combustion engine (not shown in detail) which may be a petrol engine or a Diesel engine. The exhaust gas turbocharger 3 also comprises a flow-through fresh air guide section (not shown in detail) which is arranged in the intake system, and an exhaust gas guide section (not shown in detail) which is accommodated in the exhaust system.

The rotor assembly 2 comprises a compressor wheel 4 for intake and compression of combustion air, a turbine wheel 5 for expansion of exhaust gas as well as a shaft 6 which non-rotatably connects the compressor wheel 4 with the turbine wheel 5. The shaft 6 is rotatably supported in the bearing section 1 of the exhaust gas turbocharger 3 which is positioned between the air guide section and the exhaust gas guide section.

For the inflow of the exhaust gas into the exhaust gas guide section, an inlet channel (not shown in detail) is formed in the exhaust gas guide section. The inlet channel serves to condition the exhaust gas which during operation of the combustion engine provides for the rotating movement of the turbine wheel 5. The compressor wheel 4 is also rotated by means of the shaft 6, so that it sucks in and compresses combustion air.

For low-friction rotation of the rotor assembly, bearing elements 7 are provided in the bearing section 1, which are implemented as plain bearings. The bearing elements 7 are preferably radial bearings of different designs, for example, as one-piece or multi-piece elements. For supplying lubricant, the bearing section 1 comprises a lubricant supply system 8 which may supply lubricant to the bearing elements 7. The lubricant supply system 8 comprises an inlet channel 9 and an outlet channel 10 which is generally arranged on the side of the shaft 6, which is opposite the inlet channel 9. Several supply channels ii originating at the inlet channel 9 of the lubricant supply system 8 are formed in the bearing section 1.

In order to prevent the lubricant from freely entering the adjacent exhaust gas guide section and/or the fresh air guide section sealing elements 12, preferably in the form of sealing rings, are provided in the area of the turbine wheel 5. The shaft 6 comprises a lubricant slinger ring 13 which is non-rotatably connected with the shaft 6 in the area of the compressor wheel 4 to prevent transfer of lubricant into the fresh air guide section.

During operation of the exhaust gas turbocharger 3, i.e. in other words, during rotation of the shaft 6, the lubricant flows through the bearing section 1. Thereby, a proportion of the lubricant flow is generated which due to gravity or the gravitational force, respectively, flows off quasi vertically to the earth's surface. In addition, there is a proportion of the lubricant flow which, due to the centrifugal force during rotation of the shaft 6, is distributed by it and in particular by the lubricant slinger ring 13 along corresponding trajectories in the bearing section 1 and impinges on an inner wall 15 of the bearing section. This proportion of the lubricant flow, referred to as rotating lubricant flow, cannot be captured by means of the lubricant slinger ring 13 according to the state of the art.

The illustrated exhaust gas turbocharger 3 according to the state of the art does not comprise a lubricant-rejecting element 14 so that the lubricant flow may freely impinge against the bearing section 1, as shown by flow arrows 32, where it is swirled.

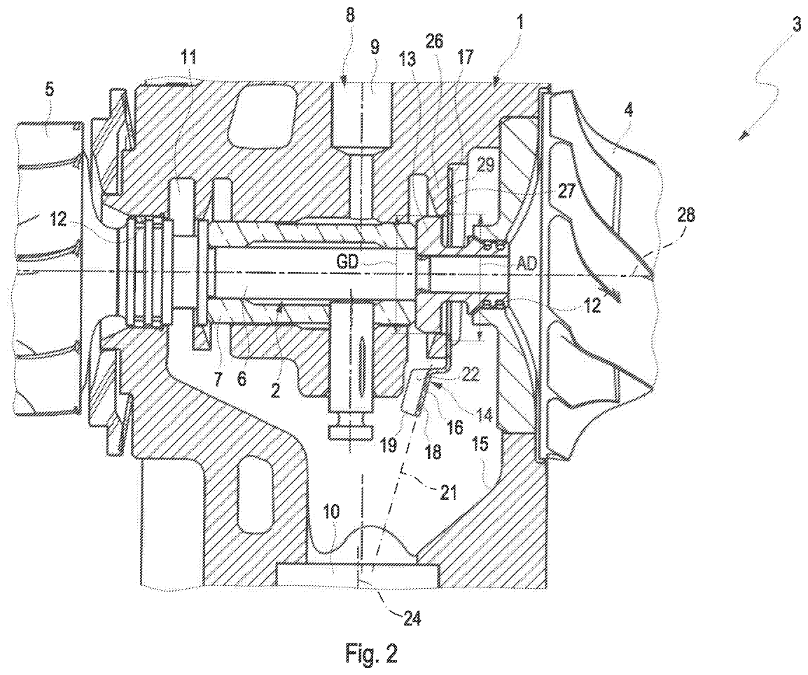

FIG. 2 illustrates an exhaust gas turbocharger 3. In order to reduce the transfer of lubricant into the fresh air guide section, a lubricant-rejecting element 14 is provided which accommodates the lubricant slinger ring 13. The lubricant-rejecting element 14 is adapted for diversion of the rotating proportion of the lubricant flow.

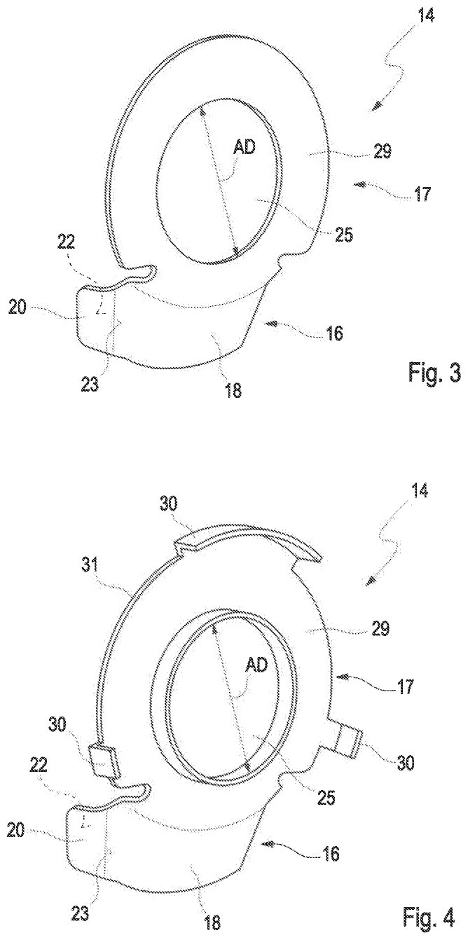

The lubricant-rejecting element 14 comprises a capturing part 16 and a fastening component 17. The fastening component 17 has an annular shape and may secure the lubricant-rejecting element 14 at the bearing section 1 in various ways, as is shown in particular in FIGS. 3 and 4.

The capturing part 16 consists of an essentially plane central portion 18 which comprises one side wall each, one first side wall 19 and one second side wall 20, which serve as baffle elements, at its two lateral surfaces 23 which extend in the radial direction relative to the rotor assembly. This means in other words that the rotating proportion of the lubricant flow may rebound at these side walls 19, 20 and can thus no longer impinge on the bearing section inner wall 15.

The central portion 18 is formed as a virtual extension 21 protruding into the outlet channel 10 and functions as a guide element, because it determines the flow direction of the lubricant which is collected in the capturing part 16. This means that it is formed inclined in the direction of the outlet channel 10 so that the virtual extension 21 preferably intersects a longitudinal axis 24 of the outlet channel 10.

The side walls 19, 20 are preferably arranged with an angle between 90° and 120° relative to the central portion 18, so that a trough-like or U-shaped profile of a cross-section of the capturing part 16 is formed. The angle is included by a virtual parallel of the longitudinal axis 28 and the side wall 19; 20, wherein the virtual parallel vertically intersects the central portion 18. By means of the side walls 19, 20, the rotating proportion of the lubricant flow is quasi captured and may be supplied to the central portion 18 via the wall surfaces 22 of the side walls 19, 20 which face the central portion 18, from where it may flow into the outlet channel 10.

For accommodating the shaft 6 or, in particular, for accommodating the lubricant slinger ring 13 which is non-rotatably connected with the shaft 6, the lubricant-rejecting element 14 comprises a mounting opening 25 with a mounting diameter AD. The value of the mounting diameter AD is at least equal to the value of a maximum outer diameter GD of the lubricant slinger ring 13.

The lubricant-rejecting element 14 may be material-bonded with the bearing section 1 or positively connected with it, whereby it is fixed non-rotatably in the bearing section 1. This means in other words that it is unmovably accommodated in the bearing section 1. For the material-bonded mounting of the lubricant-rejecting element 14, a carrier ring 26 is formed in the bearing section 1, which corresponds to a wall of a supply channel 11 in the area of a bearing element 7. The carrier ring 26 is preferably formed with a plane surface 27 which faces the lubricant-rejecting element 14. Depending on the inclination of this surface 27 related to a longitudinal axis 28 of the bearing section 1, the fastening component 17 is formed inclined relative to the capturing part 16, in particular relative to the central portion 18.

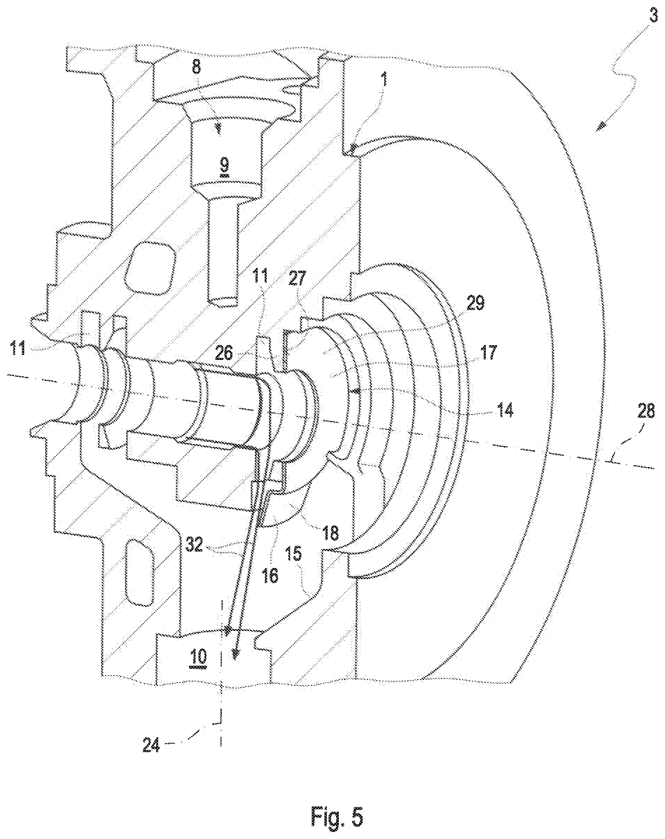

In the first exemplary embodiment according to FIGS. 3 and 5, the fastening component 17 of the lubricant-rejecting element 14 is material-bonded with the surface 27.

In a second exemplary embodiment of the lubricant-rejecting element 14 according to FIG. 4, the lubricant-rejecting element 14 is clamped in the bearing section 1. For this purpose, the fastening component 17 comprises clamping lugs 30 at its fastening ring 29, which may be distributed regularly or irregularly over the circumference of the fastening ring 29. The clamping lug 30 may be formed over a free circumference 31 of the fastening ring 29, but also several clamping lugs 30 may be formed over the free circumference 31. The free circumference of the fastening ring 29 corresponds to the annular portion which does not comprise the central portion 18.

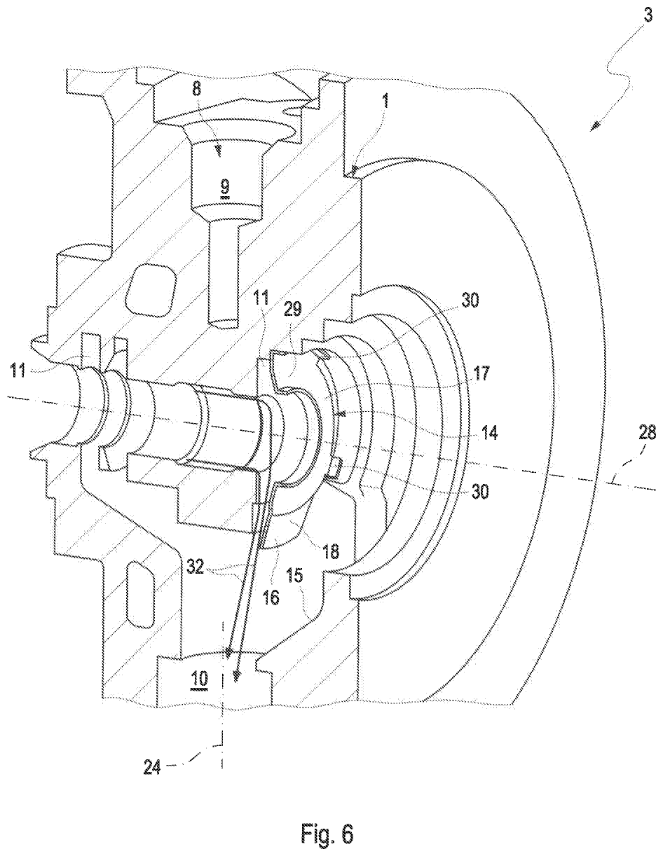

The lubricant-rejecting element 14 shown in FIG. 4 as an individual component is illustrated in FIG. 6 in the installed condition in the bearing section 1.

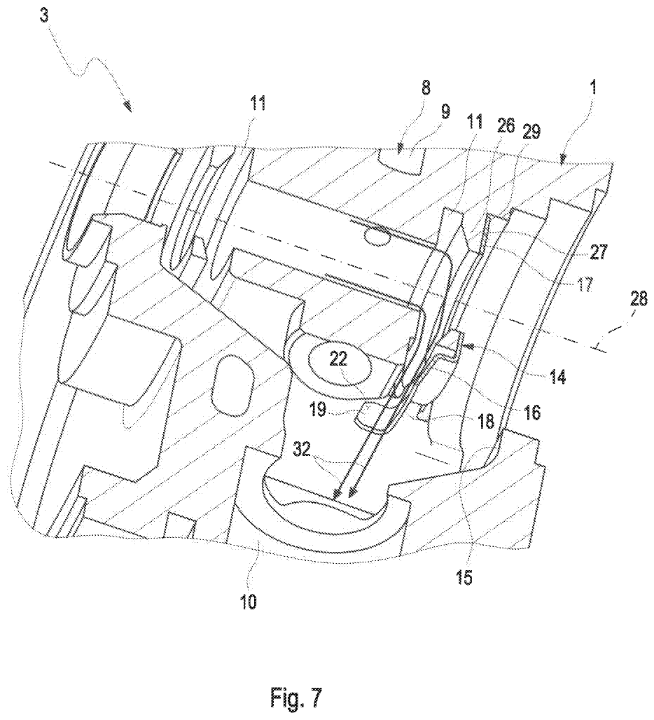

FIG. 7 illustrates the exhaust gas turbocharger 3 with the lubricant-rejecting element 14 which is material-bonded with the bearing section 1. FIG. 7 is a perspective sectional view of the lubricant-rejecting element from its end facing the outlet channel 10, i.e. in other words in a sub-view.

The lubricant-rejecting element 14 is preferably manufactured as a formed stamped component.

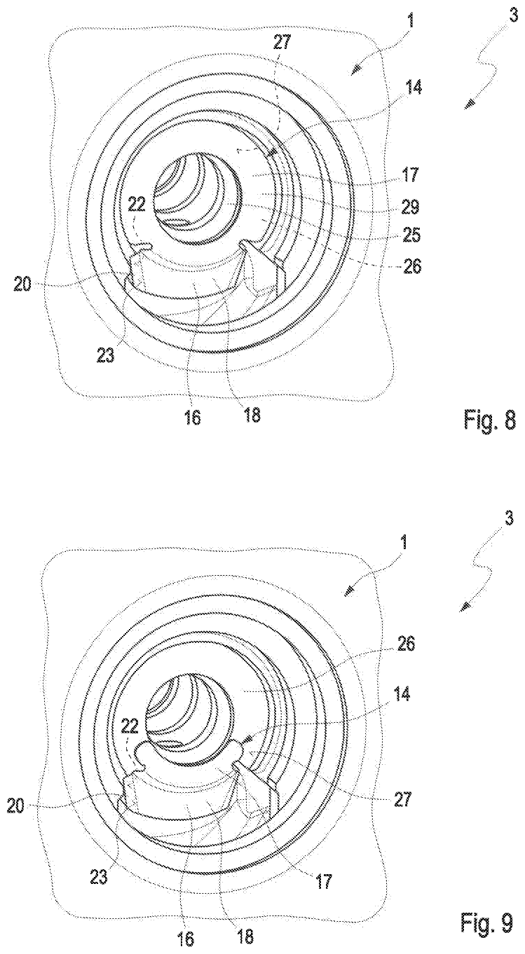

FIG. 8 illustrates the lubricant-rejecting element 14 of the first exemplary embodiment in the installed condition. FIG. 9 shows the lubricant-rejecting element 14 in a third exemplary embodiment. The fastening component 17 takes the form of an annular portion, which provides a cost-effective variant of the lubricant-rejecting element 14 because of a reduced material demand compared to the lubricant-rejecting element 14 which is a fastening component 17 formed as a complete ring. The exhaust gas turbocharger 3 which comprises the lubricant-rejecting element 14 of the third exemplary embodiment may also be provided cost-effectively, because material for material-bonding, for example an adhesive, and working time for attaching the lubricant-rejecting element 14 are reduced. The shape of the fastening component 17 may also assume any other suitable shape and is not limited to the illustrated exemplary embodiments.

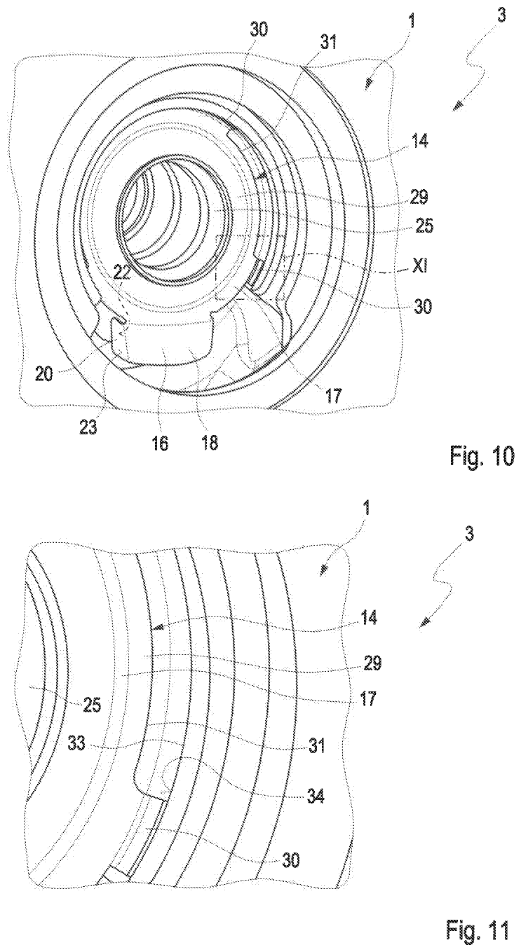

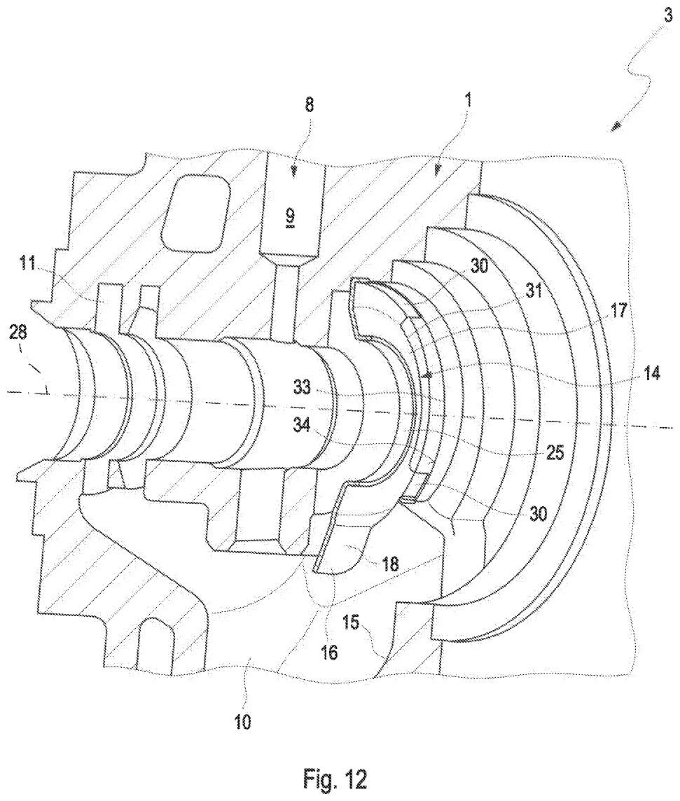

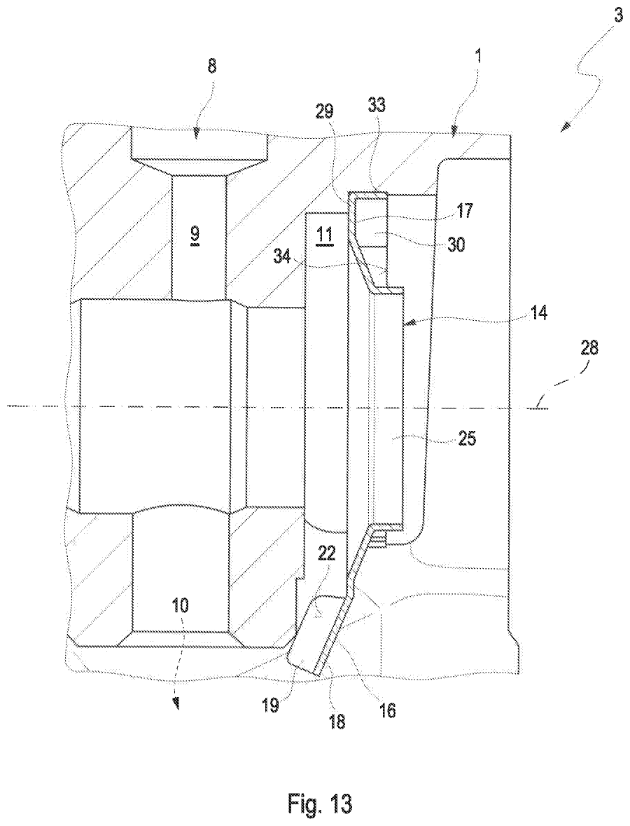

FIGS. 10 to 13 show the lubricant-rejecting element 14 in the second exemplary embodiment in the installed condition for a description of the undercut. The lubricant-rejecting element 14 has a low wall thickness, e.g. 0.5 mm, in order to achieve a resilient effect upon a load application on the clamping lugs 30. During the assembly operation, a slight overload is exerted on the clamping lugs 30, i.e. in other words, they are pressed in the direction of the mounting opening 25. After having reached their installation position, the clamping lugs 30 return into their original positions. This ensures the undercut position of the lubricant-rejecting element 14 in the bearing section 1. Preferably, a machined shoulder 33 is formed in the bearing section 1, which forms an undercut surface 34. The shoulder 33 is advantageously formed circumferentially.

1.-14. (canceled)

15. An exhaust gas turbocharger, comprising:
a flow-through exhaust gas guide section;
a flow-through fresh air guide section;
a bearing section (1) arranged between the exhaust gas guide section and the fresh air guide section;
a rotor assembly (2), comprising
a turbine wheel (5) which is rotatably accommodated in the exhaust gas guide section,
a compressor wheel (4) which is rotatably accommodated in the fresh air guide section, and
a shaft (6) which non-rotatably connects the compressor wheel (4) with the turbine wheel (5),
wherein the shaft (6) is rotatably supported in the bearing section (1);
a lubricant supply system (8) with an inlet channel (9) and an outlet channel (10) being formed in the bearing section (1), via which lubricant may be supplied to bearing elements (7) of a bearing of the shaft (6); and
a lubricant-rejecting element (14),
wherein the lubricant-rejecting element (14) comprises a baffle element (19; 20) for diversion of a rotating proportion of a lubricant flow,
wherein the baffle element (19; 20) extends in the direction of a longitudinal axis (28) of the exhaust gas turbocharger (3) and in a circumferential direction of the shaft (6) and
wherein the baffle element (19; 20) is arranged at a capturing part (16) of the lubricant-rejecting element (14) for diversion of the rotating proportion of the lubricant flow, and
wherein the capturing part (16) comprises a central portion (18) which comprises the baffle element (19; 20) arranged at one of its lateral surfaces (23) extending in the direction of the longitudinal axis (28) and in the radial direction.

16. The exhaust gas turbocharger according to claim 15,
wherein the lubricant-rejecting element (14) comprises a guide element (18) for diversion of a gravity-oriented lubricant flow proportion, wherein the guide element (18) is extending in the direction of the longitudinal axis (28) of the exhaust gas turbocharger (3) and in the direction of a longitudinal axis (24) of the outlet channel (10).

17. The exhaust gas turbocharger according to claim 15,
wherein the lubricant-rejecting element (14) is non-rotatably fixed in the bearing section (1).

18. The exhaust gas turbocharger according to claim 15,
wherein the lubricant-rejecting element (14) exhibits a U-shaped cross-section, wherein side walls (19, 20) for diverting the rotating proportion of the lubricant flow are formed and, in particular, for diverting the gravity-oriented proportion of the lubricant flow, the central portion (18) connecting the first side wall (19) with the second side wall (20) is formed.

19. The exhaust gas turbocharger according to claim 18,
wherein the central portion (18) is formed as a virtual extension (21) projecting into the outlet channel (10).

20. The exhaust gas turbocharger according to claim 15,
wherein the lubricant-rejecting element (14) comprises a fastening component (17).

21. The exhaust gas turbocharger according to claim 20,
wherein the fastening component (17) is formed for accommodating the shaft (6).

22. The exhaust gas turbocharger according to claim 20,
wherein the fastening component (17) is fixed material-bonded and/or positively connected.

23. The exhaust gas turbocharger according to claim 22,
wherein the fastening component (17) comprises a clamping element (30) for a positively connected attachment.

24. The exhaust gas turbocharger according to claim 23,
wherein the clamping element (30) is formed as undercut.

25. The exhaust gas turbocharger according to claim 23,
wherein the clamping element (30) is a clamping lug.

26. The exhaust gas turbocharger according to claim 15,
wherein the lubricant-rejecting element (14) is accommodated in the bearing section (1).

27. The exhaust gas turbocharger according to claim 15,
wherein the lubricant-rejecting element (14) is formed resting against the bearing section (1).

28. The exhaust gas turbocharger according to claim 15,
wherein the lubricant-rejecting element (14) is formed comprising a lubricant slinger ring (13) which is non-rotatably connected with the shaft (6).

29. The exhaust gas turbocharger according to claim 28,
wherein the lubricant-rejecting element (14) comprises a mounting diameter (AD) whose value is at least equal to a value of the largest outer diameter (GD) of the lubricant slinger ring (13).
